(19) United States
(12) Patent Application Publication
(10) Pub. No.: US 2010/0086868 A1
(43) Pub. Date: Apr. 8, 2010

(54) Finely Divided Epsilon-Copper Phthalocyanine Composition (Pigment Blue 15:6) For Use As Pigment

(75) Inventors: Thomas Metz, Heppenheim (DE); Gerald Mehltretter, Wiesbaden (DE); Klaus Brychcy, Frankfurt am Main (DE); Carsten Plueg, Muehltal/Niederbeerbach (DE); Wolfgang Schaefer, Hoelstein (CH)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/522,677

(22) PCT Filed: Dec. 7, 2007
(86) PCT No.: PCT/EP2007/010642

§ 371 Date: Jul. 9, 2009

(30) Foreign Application Priority Data
Jan. 12, 2007 (DE) 10 2007 001 851.9

(51) Int. Cl. G03G 9/08; C09B 47/08; C09B 67/50; C09D 5/00; C09D 11/00; C09D 11/02

(52) U.S. Cl. 430/108.21; 540/142; 106/410; 524/88

(57) ABSTRACT

The invention relates to a pigment composition of C.I. Pigment Blue 15:6, containing 0.5% to 15% by weight of an additive of the formula (1), based on the weight of the pigment, in which R¹, R², R³, R⁴, R⁵ and R⁶ independently of one another are hydrogen; C₁-C₂₂ alkyl or C₂-C₂₂ alkenyl, whose carbon chain in each case may be interrupted by one or more moieties —O—, —S—, NR⁹—, —CO— or —SO₂— and/or may be substituted one or more times by hydroxyl, halogen, aryl, heteroaryl, C₁-C₄ alkoxy and/or acetyl; C₃-C₈ cycloalkyl, whose carbon framework may be interrupted by one or more moieties —O—, —S—, —NR¹⁰—, —CO— or —SO₂— and/or may be substituted one or more times by hydroxyl, halogen, aryl, heteroaryl, C₁-C₄ alkoxy and/or acetyl; dehydroabietyl or aryl or heteroaryl, with R⁹ and R¹⁰ independently of one another being hydrogen or C₁-C₂₂ alkyl. The pigment composition of the invention is produced with application of a wet grinding process, more particularly a salt kneading operation.

The present invention relates to a pigment composition of finely divided copper phthalocyanine in the epsilon phase (Pigment Blue 15:6, CI 74160), and to a process for phase conversion from alpha or gamma to epsilon.

Of the three crystal phases of copper phthalocyanine which are of commercial importance, viz. the alpha phase (Pigment Blue 15:1 and 15:2), the beta phase (Pigment Blue 15:3 and 15:4) and the epsilon phase (Pigment Blue 15:6), the epsilon phase is the crystal phase with the most reddish blue. The epsilon phase further has high color strength and exhibits a particularly clean hue. These properties make C.I. Pigment Blue 15:6 particularly useful for specific applications for example in varnish, printing or plastics and also in the field of color filters for use in optical displays or as pigmented photoresists.

Thermodynamically, the stability of the epsilon phase is between that of the alpha and beta phases. This is an obstacle to phase-pure production of the epsilon phase.

Phase stability of copper phthalocyanines: alpha≈gamma<epsilon<beta

The epsilon phase can be produced by following various processes: during the crude blue synthesis (U.S. Pat. No. 3,051,721, U.S. Pat. No. 4,135,944), by treatment of copper phthalocyanine in organic solvents and mixtures thereof with water (DE-2 210 072, EP-1 580 239) or by salt kneading (EP-1 130 065).

It is a common feature of all these processes that special production parameters are observed and additives added to stabilize the epsilon phase to prevent conversion into the thermodynamically more stable beta phase.

Particularly in the case of the processes which utilize additives for phase stabilization would it be desirable to have such additives which have a phase-stabilizing effect in both a solvent treatment and a salt kneading operation. Hitherto, however, only phthalocyanine-based additives have been described with such a broad utility. However, they usually have the disadvantage of shifting the hue in the direction of green.

The present invention has for its object to provide an additive which makes it possible to produce a copper phthalocyanine composition having a very phase-pure epsilon phase and a very reddish hue. The desired additives should furthermore have a phase-stabilizing effect at various stages of phthalocyanine synthesis.

We have found that this object is achieved, surprisingly, by naphthyl additives of formula (1).

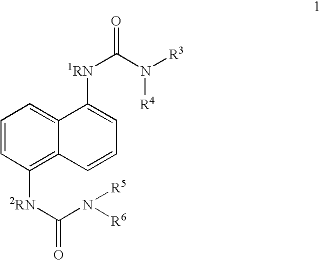

where
R¹, R², R³, R⁴, R⁵ and R⁶ are each independently hydrogen; C₁-C₂₂ alkyl or C₂-C₂₂ alkenyl, the carbon chain of which may in each case be interrupted by one or more of the groupings —O—, —S—, —NR⁹—, —CO— or SO₂—, and/or substituted one or more times by hydroxyl, halogen, aryl, heteroaryl, C₁-C₄-alkoxy and/or acetyl; C₃-C₈-cycloalkyl whose carbon scaffold may be interrupted by one or more groupings —O—, —S—, —NR¹⁰—, —CO— or SO₂— and/or substituted one or more times by hydroxyl, halogen, aryl, heteroaryl, C₁-C₄-alkoxy and/or acetyl; dehydroabietyl or aryl or heteroaryl, where
R⁹ and R¹⁹ are each independently hydrogen or C₁-C₂₂-alkyl, or where R³, R⁴, R⁵, R⁶ are a polyoxyalkylene chain which is optionally end-alkylated.

Aryl is preferably C₆-C₁₀-aryl, particularly phenyl or naphthyl. Heteroaryl is preferably a five- or six-membered heteroaromatic ring having 1, 2, 3 or 4 hetero atoms from the group consisting of N, O and S, the ring being optionally benzo-fused.

R¹, R², R⁴ and R⁶ are each preferably hydrogen.

R³ and R⁵ are each preferably (C₂-C₄-alkylene)-O—(C₁-C₁₆-alkyl).

A preferred additive for the purposes of the present invention is a compound of the general formula (2)

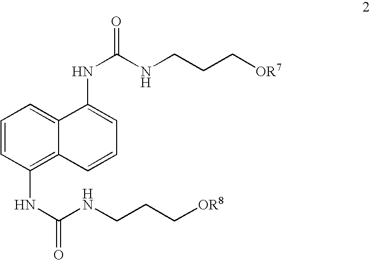

where
R⁷ and R⁸ are each independently hydrogen; C₁-C₁₉ alkyl or C₂-C₁₉ alkenyl, the carbon chain of which may in each case be interrupted by one or more of the groupings —O—, —S—, —NR⁹—, —CO— or SO₂— and/or substituted one or more times by hydroxyl, halogen, C₁-C₄-alkoxy and/or acetyl, or a radical of the formula -(AO)ₙ—Z, where A is ethylene or propylene, Z is hydrogen or C₁-C₁₆-alkyl and n is from 1 to 200, preferably 10 to 100;
C₃-C₈-cycloalkyl whose carbon scaffold may be interrupted by one or more groupings —O—, —S—, —NR¹⁰—, —CO— or SO₂— and/or substituted one or more times by hydroxyl, halogen, C₁-C₄-alkoxy and/or acetyl; where
R⁹ and R¹⁹ are each independently hydrogen or C₁-C₂₂-alkyl.

Particular preference for the purposes of the present invention is given to the additive of formula (3)

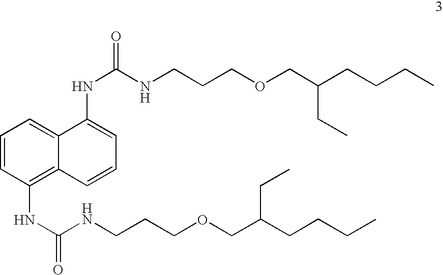

Additives of formula (1), (2) and (3) are obtainable in, a conventional manner by reaction of naphthyl diisocyanate with the corresponding amines.

The present invention provides a process for producing copper phthalocyanine in the epsilon phase, characterized in that copper phthalocyanine in the alpha phase, the gamma phase or a mixture of alpha phase and gamma phase is subjected in the presence of 1% to 50% by weight, preferably 5% to 15% by weight, of crystalline epsilon phase and in the presence of 0.5% to 15% by weight, preferably 2% to 5% by weight, of an additive of formula (1), preferably of formula (2) and most preferably of formula (3), to a wet grind and/or a solvent treatment in an organic solvent at a temperature between 30 and 250° C., the weight percentages being based on the total amount of copper phthalocyanine.

Wet grinding is to be understood as referring to customary grinding processes in bead mills or stirred ball mills. Any grinding media known in the literature can be used, examples being balls and, as materials, steel, porcelain, steatite, oxides, for example aluminum oxide, or optionally stabilized zirconium oxide, mixed oxides, for example zirconium mixed oxide, or glass, for example quartz glass. Grinding can take place at temperatures up to 150° C.; temperatures below 100° C. are usually employed. Residence time depends on the rate of phase transformation.

A particularly preferred form of wet grinding is salt kneading with a crystalline inorganic salt in the presence of an organic solvent. The crystalline inorganic salt used may be for example aluminum sulfate, sodium sulfate, calcium chloride, potassium chloride or sodium chloride, preferably sodium sulfate, sodium chloride and potassium chloride.

Useful organic solvents include for example ketones, esters, amides, sulfones, sulfoxides, nitro compounds, mono-, bis- or trishydroxy-C₂-C₁₂-alkanes, which may be substituted with C₁-C₈-alkyl and one or more hydroxyl groups. Particular preference is given to water-miscible high-boiling organic solvents based on monomeric, oligomeric and polymeric C₂-C₃-alkylene glycols, for example diethylene glycol, diethylene glycol monomethyl ether, diethylene glycol monoethyl ether, triethylene glycol, triethylene glycol monomethyl ether, triethylene glycol monoethyl ether, dipropylene glycol, dipropylene glycol monomethyl ether, dipropylene glycol monoethyl ether, propylene glycol monomethyl ether, propylene glycol monoethyl ether and liquid polyethylene glycols and polypropylene glycols, N-methylpyrrolidone and also triacetin, dimethylformamide, dimethylacetamide, ethyl methyl ketone, cyclohexanone, diacetone alcohol, butyl acetate, nitromethane, dimethyl sulfoxide and sulfolane.

The weight ratio between inorganic salt and copper phthalocyanine is preferably (2 to 8):1, in particular (5 to 6):1.

The weight ratio between organic solvent and inorganic salt is preferably (1 ml:6 g) to (3 ml:7 g).

The weight ratio between organic solvent and sum total of inorganic salt and copper phthalocyanine is preferably (1 ml:2.5 g) to (1 ml:7.5 g).

The temperature during kneading can be between 40 and 140° C., preferably 60 to 120° C. Kneading time is advantageously 4 h to 32 h, preferably 8 h to 20 h.

After salt kneading, the inorganic salt and the organic solvent are advantageously removed by washing with water and the pigment composition thus obtained is dried in a conventional manner.

Optionally, wet grinding, in particular salt kneading, is followed by solvent finishing. The solvent treatment can be carried out in an organic solvent, preferably from the group of alcohols having 1 to 10 carbon atoms, for example methanol, ethanol, n-propanol, isopropanol, butanols, such as n-butanol, isobutanol, tert-butanol, pentanols, such as n-pentanol, 2-methyl-2-butanol, hexanols, such as 2-methyl-2-pentanol, 3-methyl-3-pentanol, 2-methyl-2-hexanol, 3-ethyl-3-pentanol, octanols, such as 2,4,4-trimethyl-2-pentanol, cyclohexanol; or glycols, such as ethylene glycol, diethylene glycol, propylene glycol, dipropylene glycol, sorbitol or glycerol; polyglycols, such as polyethylene glycols or polypropylene glycols; ethers, such as methyl isobutyl ether, tetrahydrofuran, dimethoxyethane or dioxane; glycol ethers, such as monoalkyl ethers of ethylene glycol or of propylene glycol or diethylene glycol monoalkyl ethers, where alkyl may represent methyl, ethyl, propyl and butyl, examples being butyl glycols or methoxybutanol;

polyethylene glycol monomethyl ethers, in particular those having an average molar mass of 350 to 550 g/mol, and polyethylene glycol dimethyl ethers, in particular those having an average molar mass of 250 to 500 g/mol; ketones, such as acetone, diethyl ketone, methyl isobutyl ketone, methyl ethyl ketone, methyl isobutyl ketone or cyclohexanone; a mono-, bis- or trishydroxy-C₂-C₁₂-alkane compound which contains 1 or 2 keto groups and where one or more hydroxyl groups may be C₁-C₈-alkyl etherified or C₁-C₈-alkylcarbonyl esterified; aliphatic acid amides, such as formamide, dimethylformamide, N-methylacetamide or N,N-dimethylacetamide; urea derivatives, such as tetramethylurea; or cyclic carboxamides, such as N-methylpyrrolidone, valero- or caprolactam; nitriles, such as acetonitrile, aliphatic or aromatic amines, for example n-butylamine, aliphatic or aromatic hydrocarbons (optionally halogenated) such as cyclohexane, methylcyclohexane, methylene chloride, carbon tetrachloride, di-, tri- or tetrachloroethylene, di- or tetrachloroethanes or such as benzene or alkyl-, alkoxy-, nitro-, cyano- or halogen-substituted benzene, for example toluene, xylenes, mesitylene, ethylbenzene, anisole, nitrobenzene, chlorobenzene, dichlorobenzenes, trichlorobenzenes, benzonitrile or bromobenzene; or other substituted aromatics, such as phenols, cresols, nitrophenols, for example o-nitrophenol, phenoxyethanol or 2-phenylethanol; aromatic heterocycles, such as pyridine, morpholine, picoline or quinoline; 1,3-dimethyl-2-imidazolidinone; sulfones and sulfoxides, such as dimethyl sulfoxide and sulfolane; and also mixtures of these organic solvents.

Preferred solvents are C₁-C₆-alcohols, particularly methanol, ethanol, n-propanol, isopropanol, isobutanol, n-butanol, tert-butanol and tert-amyl alcohol; C₃-C₆-ketones, particularly acetone, methyl ethyl ketone or diethyl ketone; tetrahydrofuran, dioxane, ethylene glycol, diethylene glycol or ethylene glycol-C₃-C₅-alkyl ethers, particularly 2-methoxyethanol, 2-ethoxyethanol, butyl glycol, toluene, xylene, ethylbenzene, chlorobenzene, o-dichlorobenzene, nitrobenzene, cyclohexane, diacetone alcohol or methylcyclohexane.

Tetrahydrofuran is a very particularly preferred solvent.

The solvent may also contain water, acids or alkalis. Particularly suitable is tetrahydrofuran and 0.1% to 20% by weight aqueous sulfuric acid in a ratio of 1:1 to 1:3.

The solvent treatment is advantageously carried out for 1 to 8 h and at a temperature between 30 and 200° C., preferably 50 to 120° C.

The additive of the present invention can be added before and/or during wet grinding or before and/or during solvent treatment, in one or more portions, to the copper phthalocyanine, in an amount of 0.5% to 15% by weight, preferably 2% to 5% by weight. It has emerged that larger amounts (above 15% by weight) of additive greatly slow down the phase transformation from alpha to epsilon, so that the process is no longer economical.

The additive in the process of the present invention mostly ends up on the Pigment Blue 15:6 surface.

The alpha-copper phthalocyanine used can be prepared by known processes, for example proceeding from a swelling or dissolving operation in 60% to 100% by weight sulfuric acid. The use of gamma-copper phthalocyanine and also of mixtures of alpha/gamma phase is likewise possible.

The addition of the epsilon seed crystals to the alpha and/or gamma phase can take place with or without prior grinding, but preferably the mixtures are produced by swing, roll, ball, planetary ball or bead milling.

It was found that the naphthyl additives of the present invention develop their phase-stabilizing effect not only in a simple solvent treatment but also in a wet-grinding operation, as in salt kneading for example. The advantage consists in the fact that one and the same additive is suitable not only for the production of a finely divided transparent epsilon-copper phthalocyanine (particle size 20 to 90 nm, obtainable by wet grinding) but also for the production of a hiding epsilon-copper phthalocyanine (particle size 90 to 300 nm, obtainable by solvent treatment without wet grinding).

The pigment composition produced according to the present invention has a primary particle size of preferably 20 to 300 nm and a length/width ratio of (1.0 to 6.0):1, preferably (1.0 to 3.0):1, for the primary particle. The specific surface area (BET) is preferably in the range from 50 to 100 m²/g.

The present invention also provides a pigment composition of C.I. Pigment Blue 15:6, comprising 0.5% to 15% by weight, preferably 2% to 5% by weight, of an additive of formula (1), based on the weight of the pigment.

The pigment composition of the present invention, in addition to the copper phthalocyanine pigment and the additive of formula (1), may further comprise further customary auxiliaries or admixtures, for example surfactants, nonpigmentary dispersants, fillers, standardizers, resins, waxes, defoamers, antidusters, extenders, antistats, preservatives, dryness retardants, rheology control additives, wetters, antioxidants, UV absorbers and light stabilizers, preferably in an amount of 0.1% to 25% by weight, particularly 0.5% to 15% by weight, based on the total weight of the pigment composition.

Useful surfactants include anionic or anion-active, cationic or cation-active and nonionic or amphoteric substances or mixtures of these agents.

Useful anion-active substances include for example fatty acid taurides, fatty acid N-methyltaurides, fatty acid isethionates, alkylphenyl sulfonates, for example dodecylbenzenesulfonic acid, alkylnaphthalenesulfonates, alkylphenol polyglycol ether sulfates, fatty alcohol polyglycol ether sulfates, fatty acid amide polyglycol ether sulfates, alkyl sulfosuccinates, alkenylsuccinic monoesters, fatty alcohol polyglycol ether sulfosuccinates, alkanesulfonates, fatty acid glutamates, alkyl sulfosuccinates, fatty acid sarcosides; fatty acids, for example palmitic acid, stearic acid and oleic acid; the salts of these anionic substances and soaps, for example alkali metal salts of fatty acids, naphthenic acids and resin acids, for example abietic acid, alkali-soluble resins, for example rosin-modified maleate resins and condensation products based on cyanuric chloride, taurine, N,N′-diethylaminopropylamine and p-phenylenediamine. Preference is given to resin soaps, i.e., alkali metal salts of resin soaps.

Useful cation-active substances include for example quaternary ammonium salts, fatty amine oxyalkylates, polyoxyalkyleneamines, oxyalkylated polyamines, fatty amine polyglycol ethers, primary, secondary or tertiary amines, for example of alkyl-, cycloalkyl- or cyclized alkylamines, particularly fatty amines, di- and polyamines derived from fatty amines or fatty alcohols and oxyalkylates of such di- and polyamines, imidazolines derived from fatty acids, polyaminoamido or polyamine compounds or resins having an amine index between 100 and 800 mg KOH per g of polyaminoamido or polyamino compounds, and salts of these cation-active substances, such as acetates or chlorides for example.

Useful nonionigenic and amphoteric substances include for example fatty amine carboxyglycinates, amine oxides, fatty alcohol polyglycol ethers, fatty acid polyglycol esters, betaines, such as fatty acid amide N-propylbetaines, phosphoric esters of aliphatic and aromatic alcohols, fatty alcohols or fatty alcohol polyglycol ethers, fatty acid amide ethoxylates, fatty alcohol-alkylene oxide adducts and alkylphenol polyglycol ethers.

By nonpigmentary dispersants are meant substances which are not structurally derived from organic pigments. They are added as dispersants either in the course of the synthesis of pigments, but often also during the incorporation of the pigments into the application media to be colored, for example in the course of the production of varnishes or printing inks by dispersion of the pigments in appropriate binders. They can be polymeric substances, for example polyolefins, polyesters, polyethers, polyamides, polyimines, polyacrylates, polyisocyanates, block copolymers thereof, copolymers of the corresponding monomers or polymers of one class which have been modified with a few monomers from another class. These polymeric substances carry polar anchor groups such as, for example, hydroxyl, amino, imino and ammonium groups, carboxylic acid and carboxylate groups, sulfonic acid and sulfonate groups or phosphonic acid and phosphonate groups, and may also have been modified with aromatic, nonpigmentary substances. Nonpigmentary dispersants may additionally also be aromatic substances modified chemically with functional groups and not derived from organic pigments. Nonpigmentary dispersants of this kind are known to the skilled worker and in some cases are available commercially (e.g., Solsperse®, Avecia; Disperbyk®, Byk-Chemie; Efka®, Efka). A number of types will be named below, by way of representation, although in principle any desired other substances described can be employed, examples being condensation products of isocyanates and alcohols, diols or polyols, amino alcohols or diamines or polyamines, polymers of hydroxycarboxylic acids, copolymers of olefin monomers or vinyl monomers and ethylenically unsaturated carboxylic acids and carboxylic esters, urethane-containing polymers of ethylenically unsaturated monomers, urethane-modified polyesters, condensation products based on cyanuric halides, polymers containing nitroxyl compounds, polyester amides, modified polyamides, modified acrylic polymers, dispersants with a comblike structure comprising polyesters and acrylic polymers, phosphoric esters, triazine-derived polymers, modified polyethers, or dispersants derived from aromatic, nonpigmentary substances. These parent structures are in many cases modified further, by means for example of chemical reaction with further substances carrying functional groups, or by means of salt formation.

Anionic groups of the nonpigmentary dispersants, surfactants or resins used as auxiliaries may also be laked, using for example Ca, Mg, Ba, Sr, Mn or Al ions or using quaternary ammonium ions.

By fillers and/or extenders are meant a multiplicity of substances in accordance with DIN 55943 and DIN EN 971-1, examples being the various types of talc, kaolin, mica, dolomite, lime, barium sulfate or titanium dioxide. In this context it has proven particularly appropriate to make the addition before the pulverization of the dried pigment preparation.

The pigment composition of the present invention is useful for pigmentation of macromolecular organic materials of natural or synthetic origin, for example plastics, resins, varnishes, paints, electrophotographic toners and developers, electret materials, color filters and also liquid inks, printing inks and seed.

Macromolecular organic materials which can be pigmented with the pigment compositions of the present invention are, for example, cellulose compounds, such as, for example, cellulose ethers and cellulose esters, such as ethylcellulose, nitrocellulose, cellulose acetates or cellulose butyrates, natural binders, such as, for example, fatty acids, fatty oils, resins and their conversion products or synthetic resins, such as polycondensates, polyadducts, addition polymers and copolymers, such as, for example, amino resins, especially urea and melamine formaldehyde resins, alkyd resins, acrylic resins, phenoplasts and phenolic resins, such as novolaks or resols, urea resins, polyvinyls, such as polyvinyl alcohols, polyvinyl acetals, polyvinyl acetates or polyvinyl ethers, polycarbonates, polyolefins, such as polystyrene, polyvinyl chloride, polyethylene or polypropylene, poly(meth)acrylates and copolymers thereof, such as polyacrylic esters or polyacrylonitriles, polyamides, polyesters, polyurethanes, coumarone-indene and hydrocarbon resins, epoxy resins, unsaturated synthetic resins (polyesters, acrylates) with the different cure mechanisms, waxes, aldehyde and ketone resins, gum, rubber and its derivatives and latices, casein, silicones and silicone resins; individually or in mixtures.

It is unimportant whether the aforementioned high molecular mass organic compounds are present in the form of plastic masses or melts or in the form of spinning solutions, dispersions, varnishes, paints or printing inks. Depending on the intended use it proves advantageous to utilize the pigment compositions of the invention in the form of preparations or dispersions.

The present invention accordingly also provides a macromolecular organic material comprising a coloristically effective amount of a pigment composition of the present invention.

Based on the macromolecular organic material to be pigmented, the pigment composition of the present invention is usually used in an amount of 0.01 to 30% by weight and preferably 0.1% to 15% by weight.

The pigment compositions of the present invention are also useful as colorants in electrophotographic toners and developers, for example one- or two-component powder toners (also called one- or two-component developers), magnetic toners, liquid toners, polymerization toners and also specialty toners.

The pigment compositions of the present invention are further useful as colorants in powders and powder coatings, particularly in triboelectrically or electrokinetically sprayable powder coatings used for surface coating of articles made for example of metal, wood, plastic, glass, ceramic, concrete, textile material, paper or rubber.

The pigment compositions of the present invention are also useful as colorants in ink jet inks on both an aqueous and a nonaqueous basis and also in such inks which operate by the hot melt method.

Ink jet inks generally contain altogether 0.5% to 15% by weight and preferably 1.5% to 8% by weight (reckoned dry) of one or more of the pigment compositions of the present invention.

Microemulsion inks are based on organic solvents, water and, if appropriate, an additional hydrotropic substance (interface mediator). Microemulsion inks generally contain 0.5% to 15% by weight and preferably 1.5% to 8% by weight of one or more of the pigment compositions of the present invention, 5% to 99% by weight of water and 0.5% to 94.5% by weight of organic solvent and/or hydrotropic compound.

“Solvent based” ink jet inks contain preferably 0.5% to 15% by weight of one or more of the pigment compositions of the present invention and 85% to 99.5% by weight of organic solvent and/or hydrotropic compounds.

Hot melt inks are usually based on waxes, fatty acids, fatty alcohols or sulfonamides which are solid at room temperature and liquefy on heating, the preferred melting range lying between about 60° C. and about 140° C. Hot melt ink jet inks consist for example essentially of 20% to 90% by weight of wax and 1% to 10% by weight of one or more of the pigment compositions of the present invention. Additionally present may be 0% to 20% by weight of an additional polymer (as “dye dissolver”), 0% to 5% by weight of dispersing assistant, 0% to 20% by weight of viscosity modifier, 0% to 20% by weight of plasticizer, 0% to 10% by weight of tack additive, 0% to 10% by weight of transparency stabilizer (which prevents crystallization of the waxes for example) and 0% to 2% by weight of antioxidant.

The pigment compositions of the present invention are further useful as colorants for color filters not only for additive color production but also for subtractive color production, as for example in electro-optical systems such as television screens, liquid crystal displays (LCDs), charge coupled devices, plasma displays or electroluminescent displays, which in turn can be active (twisted nematic) or passive (supertwisted nematic) ferroelectric displays or light-emitting diodes, and also as colorants for electronic inks (e-inks) or electronic paper (e-paper).

In relation to the production of color filters, not only reflecting but also transparent color filters, pigments in the form of paste or as pigmented photoresists in suitable binders (acrylates, acrylic esters, polyimides, polyvinyl alcohols, epoxies, polyesters, melamines, gelatin, caseins) are applied to the respective LCD components (for example TFT-LCD=Thin Film Transistor Liquid Crystal Displays or for example ((S) TN-LCD=(Super) Twisted Nematic-LCD). As well as high thermal stability, a high pigment purity is also a prerequisite for a stable paste or pigmented photoresist. In addition, the pigmented color filters can also be applied by ink jet printing processes or other suitable printing processes.

The reddish blues of the pigment compositions of the present invention are particularly useful for the color filter color set of red-green-blue (R,G,B). These three colors are present side by side as separate dots of color which, when backlit, produce a full-color picture.

Typical colorants for the red dot are pyrrolopyrrole, quinacridone and azo pigments, for example P.R. 254, P.R. 209, P.R. 175 and P.O. 38, individually or mixed.

Coloristic tests showed that the pigment composition of the present invention has a brilliant hue and is also capable of achieving high transparency in the masstone.

Phase purity was demonstrated for the pigments produced, in the epsilon phase, by means of IR spectroscopy and x-ray powder diffractograms.

### EXAMPLE 1

### Solvent Treatment in the Presence of Additive of Formula (3)

In a 2 l flask, 50 g of a 7/3 mixture of pulverulent alpha/epsilon-copper phthalocyanine (preground dry in a swing mill, unfinished), 2 g of the additive of formula (3), 420 ml of tetrahydrofuran and 630 ml of water were stirred to form a homogeneous mixture. Then, the mixture was refluxed for 8 h. After this solvent treatment, the suspension was filtered off, the press cake was washed with water at 50° C., dried in a convection oven at 80° C. for 16 h and pulverized with an IKA mill to obtain 51.3 g of a Pigment Blue 15:6 composition.

### EXAMPLE 2

### Solvent Treatment in the Presence of Additive of Formula (3)

In a 1 l flask, 24 g of a 9/1 mixture of pulverulent alpha/epsilon-copper phthalocyanine (preground dry in a swing mill, unfinished), 1 g of the additive of formula (3), 217 g of tetrahydrofuran and 256 g of dilute sulfuric acid (5% by weight) were stirred to form a homogeneous mixture. Then, the mixture was refluxed for 6 h. After this solvent treatment, the suspension was filtered off, the press cake was washed with water at 50° C., dried in a convection oven at 60° C. for 18 h and pulverized with an IKA mill to obtain 22.4 g of a Pigment Blue 15:6 composition.

### EXAMPLE 3

### Solvent Treatment in the Presence of 1 g of Additive of Formula (2) Where R⁷═R⁸═(CH₂)₂(CH(CH₃))₂(CH₂CH(CH₃))₂CH₃)

The procedure was similar to Example 2 to obtain 23.1 g of the corresponding Pigment Blue 15:6 composition.

### BEISPIEL 4

### Solvent Treatment in the Presence of 1 g of Additive of Formula (2) Where R⁷═R⁸═(CH₂)₆CH(CH₃)₂

The procedure was similar to Example 2 to obtain 22.8 g of the corresponding Pigment Blue 15:6 composition.

### EXAMPLE 5

### Solvent Treatment in the Presence of 0.25 g of Additive of Formula (2) Where R⁷═R⁸═[CH₂CH₂O]₄₄CH₃ (=Mpeg 2000) and 0.5 g of Additive of Formula (3)

The procedure was similar to Example 2 to obtain 21.9 g of the corresponding Pigment Blue 15:6 composition.

### EXAMPLE 6

### Salt Kneading in the Presence of Additive of Formula (3)

A 1 l laboratory kneader (Werner & Pfleiderer) was filled with 67.5 g of alpha copper phthalocyanine, 7.5 g of epsilon copper phthalocyanine as nuclei, 3 g of additive of formula (3), 450 g of NaCl and 120 ml of diethylene glycol. Kneading time was 16 h and kneading temperature was about 95° C. On completion of kneading the kneaded mass was transferred into a 6 l flask and stirred with 4000 ml of dilute hydrochloric acid (5% by weight) at room temperature for 2 h. After this solvent treatment, the suspension was filtered off and the presscake was washed with water at 50° C., dried in a convection oven at 80° C. for 16 h and pulverized with an IKA mill to obtain 76 g of a Pigment Blue 15:6 composition.

### Physical Data and Coloristic Test Results:

| | | Primary particle size | Length/width | |
|---|---|---|---|---|
| Example | XRD¹ | [nm]² | ratio² | Hue (dH)³ |
| 1 | 100% | 100 | 3.19:1 | +1.88 |
| | epsilon | | | |
| 2 | 100% | 262 | 5.20:1 | +2.91 |
| | epsilon | | | |
| 3 | 100% | 115 | 2.89:1 | — |
| | epsilon | | | |
| 4 | 100% | 136 | 3.66:1 | — |
| | epsilon | | | |
| 5 | 100% | 109 | 3.43:1 | — |
| | epsilon | | | |
| 6 | 100% | 71 | 1.88:1 | +1.44 |
| | epsilon | | | |

¹x-ray powder diagram in transmission measurement
²determined by means of transmission electron microscopy
³alkyd-melamine varnish versus a PB15:6 sample prepared as per DE-2 210 072 (Example 4). Hue determined with DataColor (CIELAB system): when dH = positive number = reddish blue, when dH = negative number = greenish blue.

1) A process for producing copper phthalocyanine in the epsilon phase, comprising the step of subjecting the copper phthalocyanine in the alpha phase, the gamma phase or a mixture of alpha phase and gamma phase in the presence of 1% to 50% by weight of crystalline epsilon phase and in the presence of 0.5% to 15% by weight of an additive of formula (1), 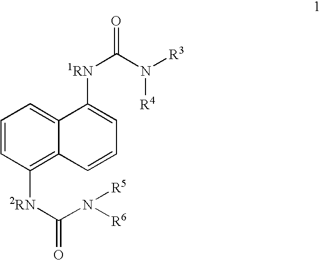
wherein
R¹, R², R³, R⁴, R⁵ and R⁶ are each independently hydrogen; C₁-C₂₂ alkyl or C₂-C₂₂ alkenyl, the carbon chain of which, optionally, are interrupted by one or more of the groupings —O—, —S—, —NR⁹—, —CO— or SO₂—, and/or substituted one or more times by hydroxyl, halogen, aryl, heteroaryl, C₁-C₄-alkoxy and/or acetyl; C₃-C₈-cycloalkyl whose carbon scaffold is optionally interrupted by one or more groupings —O—, —S—, —CO— or SO₂— and/or substituted one or more times by hydroxyl, halogen, aryl, heteroaryl, C₁-C₄-alkoxy and/or acetyl; dehydroabietyl or aryl or heteroaryl, wherein
R⁹ and R¹⁰ are each independently hydrogen or C₁-C₂₂-alkyl,
or wherein R³, R⁴, R⁵, R⁶ are a polyoxyalkylene chain which is optionally end-alkylated,
to a wet grind, a solvent treatment or both in an organic solvent at a temperature between 30 and 250° C., the weight percentages being based on the total amount of copper phthalocyanine.

2) The process as claimed in claim 1, wherein the additive of formula (1) is used in an amount of 2% to 5% by weight.

3) The process as claimed in claim 1, wherein the wet grind is a salt knead with a crystalline inorganic salt in the presence of an organic solvent.

4) The process as claimed in claim 3, wherein the organic solvent is a C₂-C₃-alkylene glycol or tetrahydrofuran.

5) The process as claimed in claim 3, wherein the salt knead is carried out in the presence of 0.5% to 15% by weight of the additive of formula (1).

6) The process as claimed in claim 1, wherein the additive is a compound of formula (2) 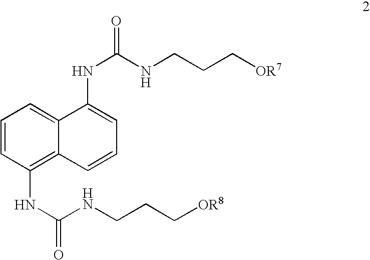
wherein
R⁷ and R⁸ are each independently hydrogen; C₁-C₂₂ alkyl or C₂-C₂₂ alkenyl, the carbon chain of which, optionally, are interrupted by one or more of the groupings —O—, —S—, —NR⁹—, —CO— or SO₂— and/or substituted one or more times by hydroxyl, halogen, C₁-C₄-alkoxy and/or acetyl; or a radical of the formula -(AO)ₙ—Z, where A is ethylene or propylene, Z is hydrogen or C₁-C₁₆-alkyl and n is from 1 to 200;
C₃-C₈-cycloalkyl whose carbon scaffold is optionally interrupted by one or more of the groupings —O—, —S—, —NR¹⁰—, —CO— or SO₂— and/or substituted one or more times by hydroxyl, halogen, C₁-C₄-alkoxy and/or acetyl; wherein R⁹ and R¹⁰ are each independently hydrogen or C₁-C₂₂-alkyl.

7) The process as claimed in claim 1, wherein the additive is a compound of formula (3)

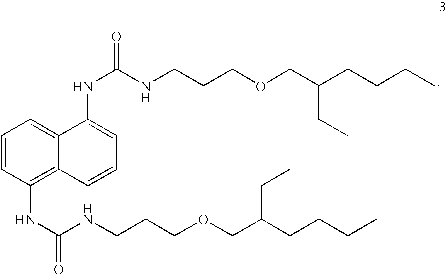

8) A pigment composition of C.I. Pigment Blue 15:6, comprising 0.5% to 15% by weight of an additive of formula (1), based on the weight of the pigment, 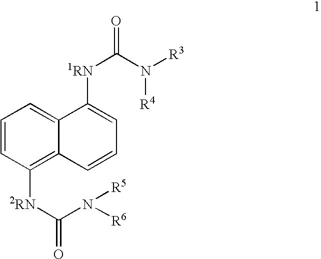
wherein
R¹, R², R³, R⁴, R⁵ and R⁶ are each independently hydrogen; C₁-C₂₂ alkyl or C₂-C₂₂ alkenyl, the carbon chain of which may, optionally, be interrupted by one or more of the groupings —O—, —S—, —NR⁹—, —CO— or SO₂—, and/or substituted one or more times by hydroxyl, halogen, aryl, heteroaryl, C₁-C₄-alkoxy and/or acetyl;
C₃-C₈-cycloalkyl whose carbon scaffold is, optionally, interrupted by one or more of the groupings —O—, —S—, —NR¹⁰—, —CO— or SO₂— and/or substituted one or more times by hydroxyl, halogen, aryl, heteroaryl, C₁-C₄-alkoxy and/or acetyl; dehydroabietyl or aryl or heteroaryl, where
R⁹ and R¹⁰ are each independently hydrogen or C₁-C₂₂-alkyl; or wherein R³, R⁴, R⁵, R⁶ are a polyoxyalkylene chain optionally end-alkylated.

9) The pigment composition as claimed in claim 8, wherein the additive is a compound of formula (2) 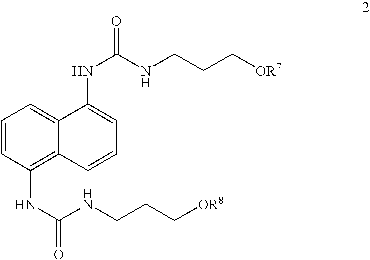
wherein
R⁷ and R⁸ are each independently hydrogen; C₁-C₂₂ alkyl or C₂-C₂₂ alkenyl, wherein the carbon chain of which is, optionally, interrupted by one or more of the groupings —O—, —S—, —NR⁹—, —CO— or SO₂— and/or substituted one or more times by hydroxyl, halogen, C₁-C₄-alkoxy and/or acetyl; or a radical of the formula (AO)ₙ—Z, where A is ethylene or propylene, Z is hydrogen or C₁-C₁₅-alkyl and n is from 1 to 200;
C₃-C₈-cycloalkyl whose carbon scaffold is, optionally, interrupted by one or more of the groupings —O—, —S—, —CO— or SO₂— and/or substituted one or more times by hydroxyl, halogen, C₁-C₄-alkoxy and/or acetyl; wherein
R⁹ and R¹⁰ are each independently hydrogen or C₁-C₂₂-alkyl.

10) The pigment composition as claimed in claim 8, wherein the additive is a compound of formula (3)

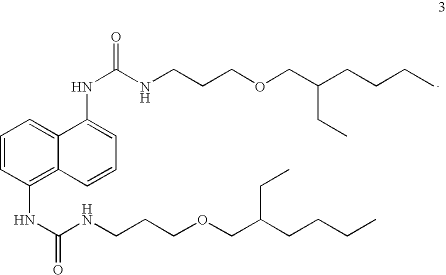

11) The pigment composition as claimed in claim 8, wherein the particles of the pigment composition have a primary particle size of 20 to 300 nm and a length/width ratio in the range from 1.0 to 6.0:1 for the primary particles.

12) A macromolecular organic material pigmented by the pigment composition as claimed in claim 1.

13) A composition pigmented by a pigment composition as claimed in claim 1, wherein the composition is selected from the group consisting of plastics, resins, varnishes, paints, electrophotographic toners, electrophotographic developers, electret materials, color filters, liquid inks and printing inks.

14. Seed pigmented by a pigment composition as claimed in claim 1.
